(19) United States
(12) Patent Application Publication
(10) Pub. No.: US 2014/0306660 A1
(43) Pub. Date: Oct. 16, 2014

(54) CHARGING SYSTEM

(71) Applicant: MAKITA CORPORATION, Anjo-shi (JP)

(72) Inventors: Hitoshi SUZUKI, Anjo-shi (JP); Masafumi NODA, Anjo-shi (JP)

(21) Appl. No.: 14/250,839

(22) Filed: Apr. 11, 2014

(30) Foreign Application Priority Data
Apr. 16, 2013 (JP) 2013-085607

(51) Int. Cl. H02J 7/00

(52) U.S. Cl. CPC H02J 7/0045
USPC 320/110

(57) ABSTRACT

In a charging system in which a charging current flows to a cell via power supply lines in a state where a charger and a battery pack are connected, two FETs for opening and closing a route in each power supply line are provided both at the charger side and the battery pack side. When the charger and the battery pack are connected to each other and FETs at the charger side and FETs at the battery pack side are set to be open, the power supply lines between FETs at the charger side and FETs at the battery pack side can be used as a communication line.

This application claims priority to Japanese patent application serial number 2013-85607, the contents of which are incorporated herein by reference.

### BACKGROUND OF THE INVENTION

1. Field of the Invention

The present invention relates to a charging system in which a charger and a battery pack can be connected to each other directly or indirectly via a separate instrument. A charging current can flow to a cell of the battery pack via power supply lines when the charger and the battery pack are connected.

2. Description of the Related Art

Japanese Laid-Open Patent Publication No. 2012-095417 discloses a technology relative to a charger that is used to charge a battery pack serving as a power supply for an electric power tool.

The charger disclosed in Japanese Laid-Open Patent Publication No. 2012-095417 includes a pair of power supply terminals and a plurality of communication terminals. When installing the battery pack onto the charger, power supply terminals and communication terminals between the battery pack and charger are connected. Installation may be accomplished by sliding the battery pack onto the charger. When the battery pack is connected to the charger, charging current flows from the charger to the battery pack via the power supply terminals. Data can be transmitted between microprocessors of the charger and the battery pack via the communication terminals.

However, when the number of terminals such as the power supply terminal and the communication terminal increases, the likelihood of a terminal contact failure between the charger and the battery pack may increase.

Japanese Patent No. 4933298 discloses a technology for solving the above problem, in which the power supply terminal is used as the communication terminal and vice versa. Thus, the number of terminals can be reduced.

In more detail, Japanese Patent No. 4933298 discloses a method in which data communication is performed using an inductance component in the cell of the battery pack and a charging power supply line that can be used as a communication line. Accordingly, the power supply terminal can be used for communication, and it is not necessary to have a dedicated communication terminal. As a result, it is possible to reduce the number of terminals.

However, in the method in which communication is performed using the inductance component in the cell of the battery pack, communication can be performed only between the battery pack and the charger that have the same inductance component in the cells. That is, communication cannot be performed between the battery pack and the charger that have different inductance components in the cells.

Thus, there is a need in the art to reduce the number of terminals between a charger and a battery pack. Also, a reduction in the likelihood of terminal contact failure between the terminals during communication via a charging power supply line will be comparatively reduced when using an increased number of terminals.

### SUMMARY OF THE INVENTION

According to one aspect of the present invention, there is provided a charging system in which a charger and a battery pack can be connected to each other directly or indirectly via a separate instrument. A charging current can flow to a cell of the battery pack via power supply lines in a state where the charger and the battery pack are connected. Further, each power supply line at the charger side and the battery pack side is provided with a switch for opening and closing a route of each power supply line. When the charger and the battery pack are connected to each other and the switch at the charger side and the switch at the battery pack side are set to be open, power supply lines between the switch at the charger side and the switch at the battery pack side can be used as a communication line

For this reason, it is not necessary to separately provide a power line and a communication line between the charger and the battery pack (or a separate instrument). That is, the connection terminals of the power supply lines between the charger and the battery pack (or the separate instrument) can be used for communication. Accordingly, it is not necessary to have a dedicated communication terminal. As a result, it is possible to reduce the number of terminals and decrease the likelihood of a terminal contact failure between the charger and the battery pack (or the separate instrument).

Further, when the switch at the charger side and the switch at the battery pack side are open, the power supply lines between the switch at the charger side and the switch at the battery pack side are used as the communication line. Accordingly, the power supply line used as the communication line is electrically disconnected from the cell of the battery pack and communication is not affected by a cell specification of the battery pack.

According to another aspect of the invention, when it is detected that a charging current becomes equal to or less than a predetermined value, the switch at the charger side and the switch at the battery pack in the power supply lines are set to be open.

For this reason, it is ensured that the switch at the charger side and the switch at the battery pack side in the power supply lines can be opened when charging of the battery pack is completed.

According to another aspect of the invention, the charging system may further include an interlock means for prohibiting the inflow of charging current to the communication line. The interlock means can also prevent the inflow of a discharging current from the battery pack when the switch at the charger side or the switch at the battery pack side in the power supply lines is set to be closed.

For this reason, charge current does not flow to the communication line due to an erroneous operation of a microprocessor while the battery pack is being charged.

According to another aspect of the invention, when communication is performed using the communication line, the interlock means opens both the switch at the charger side and the switch at the battery pack side in the power supply lines.

For this reason, charging is not started due to an erroneous operation of a microprocessor or the like when communication is performed between the charger and the battery pack.

According to another aspect of the invention, the switch at the battery pack side includes two switching elements that are connected in series to each other and a diode that is connected in parallel to one of the switching elements such that charging current flows. Further, when the charging current is equal to or less than a predetermined current value, one of the switching elements connected in parallel to the diode is set to be OFF, and when the charging current exceeds the predetermined current value, one of the switching elements is set to be ON.

For this reason, when the switching element is set to be OFF, current flowing from the battery pack to the charger can be shut off by the diode.

Further, when a charging current exceeds the predetermined current value and one of the switching elements is set to be ON, current flowing through the diode decreases and heat generation of the diode is suppressed.

According to the above, communication is performed via the charging power supply line regardless of the cell specification of the battery pack. Thus, it is not necessary to have the dedicated communication terminal. In this way, the number of terminals between the charger and the battery pack can be reduced and the likelihood of terminal contact failure between the terminals can be reduced.

### BRIEF DESCRIPTION OF THE DRAWINGS

FIG. 1 shows a schematic perspective view of a charging system according to one embodiment of the invention.

FIG. 2 shows an electric circuit diagram of the charging system.

FIG. 3 shows a flow chart of a charger in the charging system.

FIG. 4 shows a flow chart of a charger in the charging system.

FIG. 5 shows a flow chart of a battery pack in the charging system.

FIG. 6 shows an electric circuit diagram of the charging system according to an embodiment.

FIG. 7 shows a schematic perspective view of a charging system according to another embodiment of the invention.

FIG. 8 shows a schematic perspective view of the charging according to another embodiment of the invention.

FIG. 9 shows an electric circuit diagram of the charging system according to another embodiment of the invention.

FIG. 10 shows a flow chart of a charger in the charging system.

FIG. 11 shows a flow chart of a charger in the charging system.

FIG. 12 shows a flow chart of an adapter in the charging system.

FIG. 13 shows a flow chart of an electric power tool in the charging system.

FIG. 14 shows a flow chart of a battery pack in the charging system.

### DETAILED DESCRIPTION OF THE INVENTION

Each of the additional features and teachings disclosed above and below may be utilized separately or in conjunction with other features and teachings to provide an improved charging system. Representative examples of the present teaching, which examples utilize many of these additional features and teachings both separately and in conjunction with one another, will now be described in detail with reference to the attached drawings. This detailed description is merely intended to teach a person of skill in the art further details for practicing preferred aspects of the present teachings and is not intended to limit the scope of the invention. Only the claims define the scope of the claimed invention. Therefore, combinations of features and steps disclosed in the following detailed description may not be necessary to practice the invention in the broadest sense, and are instead taught merely to particularly describe representative examples of the invention. Moreover, various features of the representative examples and the dependent claims may be combined in ways that are not specifically enumerated in order to provide additional useful examples of the present teachings.

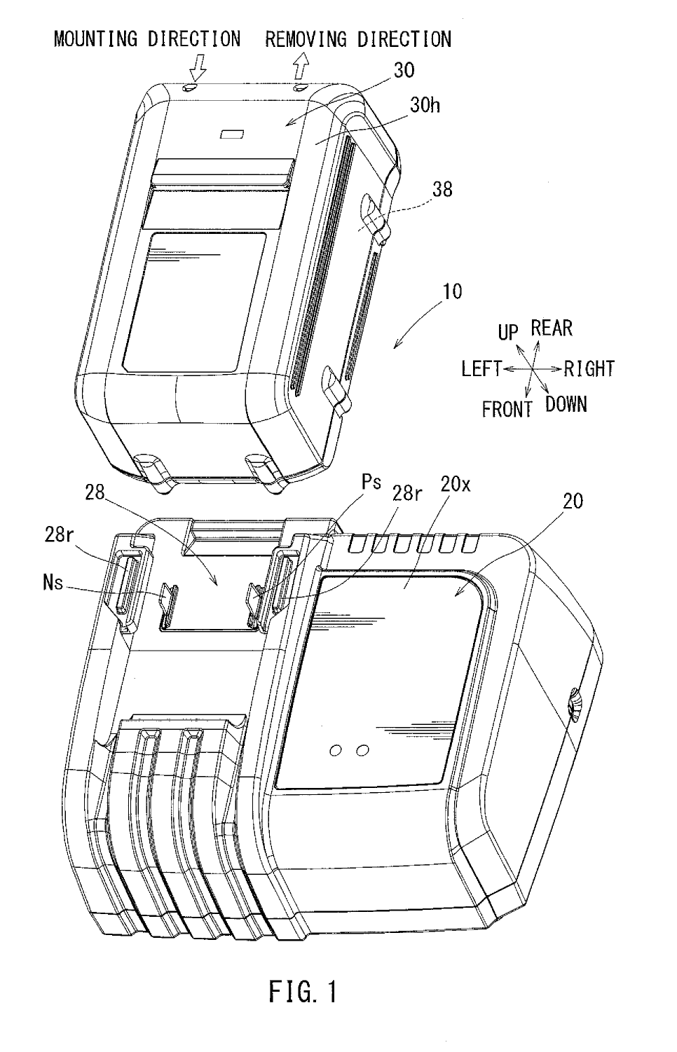

A charging system 10 according to certain embodiments of the present invention will be described below with reference to FIGS. 1 to 6.

As shown in FIG. 1, the charging system 10 in an embodiment includes a charger 20 and a battery pack 30 charged by the charger 20. The charging system 10 is configured in such a manner that a charging line, through which a charging current flows between the charger 20 and the battery pack 30. The charging line can be used as a communication line through which data is transmitted and received between a microprocessor 24 of the charger 20 and a control microprocessor 36 of the battery pack 30, and vice versa.

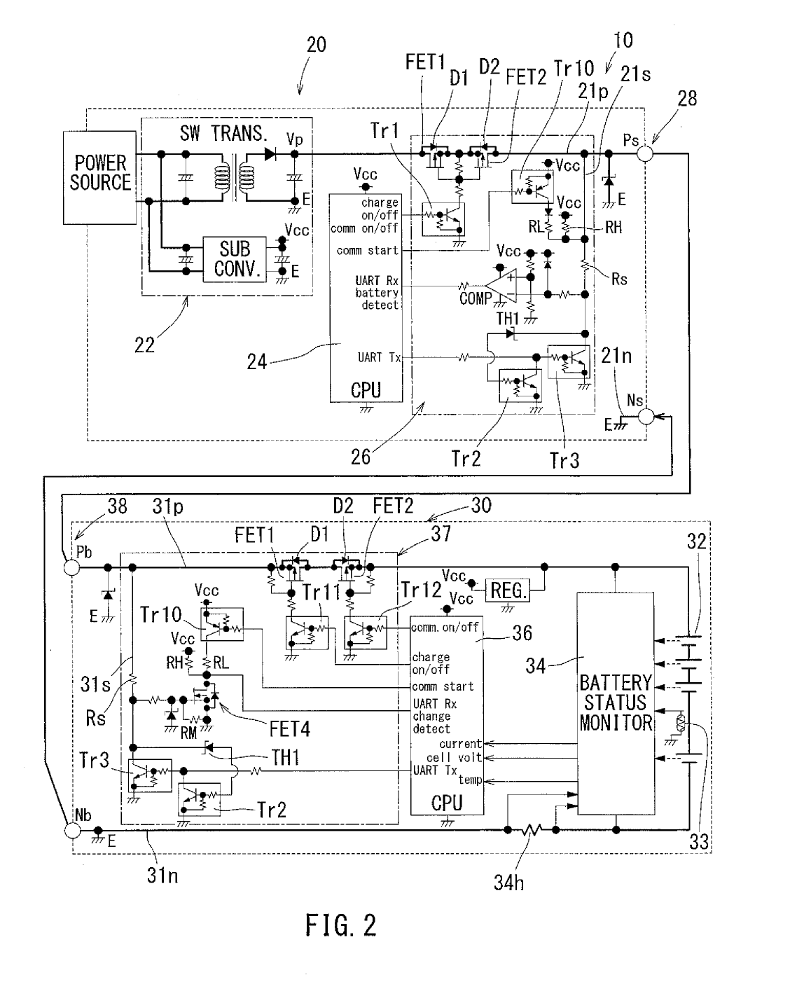

The charger 20 can charge a cell 32 (a secondary cell) of the battery pack 30. As shown in FIG. 1, the charger 20 includes a box-shaped housing 20x. A connection receiving portion 28 is formed at an upper left position of the housing 20x, and a connection portion 38 of the battery pack 30 is connected to the connection receiving portion 28. Receiving rails 28r are provided on the right and the left sides of the connection receiving portion 28 to extend in a front and rear direction, and a positive terminal Ps and a negative terminal Ns are provided between the right and the left receiving rails 28r. A positive terminal Pb and a negative terminal Nb (refer to FIG. 2) are provided in the connection portion 38 of the battery pack 30 at positions that correspond to positions of the positive terminal Ps and the negative terminal Ns of the charger 20.

For this reason, as shown in FIG. 1, it is possible to connect the battery pack 30 to the charger 20 by fitting the connection portion 38 of the battery pack 30 along the receiving rails 28r of the connection receiving portion 28 of the charger 20 from the rear side and by sliding the battery pack 30 toward the front side. The battery pack 30 becomes connected to the charger 20, and the positive terminal Pb and the negative terminal Nb of the battery pack 30 become respectively connected to the positive terminal Ps and the negative terminal Ns of the charger 20.

As shown in FIG. 2, a power supply circuit 22, the microprocessor 24, a charging and communication switching circuit 26 are provided in the housing 20x of the charger 20.

The power supply circuit 22 converts AC power from a household AC power supply into DC power to obtain a charging DC power supply (Vp) and a control DC power supply (a Vcc power supply). The charging DC power supply of the power supply circuit 22 is used to charge the battery pack 30. As shown in FIG. 2, an output terminal Vp and a ground terminal (E) of the charging DC power supply are respectively connected to the positive terminal Ps and the negative terminal Ns via power supply lines 21p and 21n.

That is, the output terminal Vp of the charging DC power supply is connected to the positive terminal Ps via switching elements FET1 and FET2 (to be described later) and the power supply line 21p. The negative terminal Ns is connected to the ground terminal E of the charging DC power supply via the power supply line 21n.

The control DC power supply (the Vcc power supply) of the power supply circuit 22 is used as a constant voltage power supply for the microprocessor 24, the charging and communication switching circuit 26.

The microprocessor 24 is configured to perform a charging control of the battery pack 30 (the cell 32) and a switching control (to be described later) of the charging and communication switching circuit 26. Further, the microprocessor 24 is configured to send data to the control microprocessor 36 of the battery pack 30 after the power supply line 21p is switched to a line for communication by the charging and communication switching circuit 26.

The battery pack 30 is used as a power supply for an electric power tool (not shown), and can be charged with the charger 20. A housing 30h of the battery pack 30 is provided with the connection portion 38 (refer to FIG. 2) that is connected to the charger 20 or the electric power tool (not shown). The positive terminal Pb and the negative terminal Nb are provided at predetermined positions of the connection portion 38 to be connected to the positive terminal Ps and the negative terminal Ns of the charger 20.

As shown in FIG. 1, the housing 30h of the battery pack 30 is a square-shaped container, and contains a plurality of column-shaped cells 32 (the secondary cells) that are connected in series to each other. As shown in FIG. 2, a positive electrode and a negative electrode of an assembly of cells 32 (hereinafter termed cell 32) are respectively connected to the positive terminal Pb and the negative terminal Nb of the connection portion 38 via power supply lines 31p and 31n.

That is, the positive terminal of the cell 32 is connected to the positive terminal Pb via the switching elements FET1 and FET2 (to be described later) and the power supply line 31p. The negative terminal of the cell 32 is connected to the negative terminal Nb via a shunt resistance 34h for detecting a charging current or a discharging current and the power supply line 31n.

A cell monitoring IC 34, a control microprocessor 36, a charging and a communication switching circuit 37 are provided in the housing 30h of the battery pack 30.

The cell monitoring IC 34 is a microprocessor that monitors the voltage of the cell 32, the charging current (detected by the shunt resistance 34h), and the cell temperature (detected by a thermometer 33).

The control microprocessor 36 is configured to perform a charging control or a discharging control based on various data of the cell monitoring IC 34. The control microprocessor 36 is configured to transmit data to the microprocessor 24 of the charger 20. This occurs after the control microprocessor 36 controls the charging and communication switching circuit 37 (to be described later) to switch the route of the power supply line 31p to a line for communication.

The charging and communication switching circuit 26 of the charger 20 switches the power supply line 21p of the charger 20 to a line for charging or a line for communication.

The charging and communication switching circuit 26 of the charger 20 includes the switching elements FET1 and FET2 (hereinafter termed FET1 and FET2), that open and close a route of the power supply line 21p, and a transistor Tr1 that operates FET1 and FET2. FET1 and FET2 are provided in the power supply line 21p to be connected in series to each other. When the transistor Tr1 is set to be ON or OFF based on a signal (a charge ON/OFF signal) from the microprocessor 24, FET1 and FET2 are also set to be ON or OFF at the same time. That is, FET1 and FET2 close or open the route of the power supply line 21p at the same time. A diode D1 is connected in parallel to FET1 such that a charging current is allowed to flow. A diode D2 is connected in parallel to FET2 such that a charging current is shut off. Accordingly, when FET1 and FET2 are OFF (when the line is in an open state), a charging DC voltage (Vp) of the power supply circuit 22 is not applied to the positive terminal Ps of the charger 20.

As shown in FIG. 2, a communication line 21s is connected to the positive terminal Ps of the charger 20. A control DC power supply voltage (a Vcc power supply voltage) is applied to the communication line 21s via a high impedance resistance RH. The high impedance resistance RH is connected in parallel to a series circuit of a transistor Tr10 and a low impedance resistance RL. The transistor Tr10 can be set to be ON and OFF based on a signal (a comm start signal) from the microprocessor 24.

The input terminal of the communication comparator COMP is connected to the communication line 21s, and the output terminal of the comparator COMP is connected to the communication input terminal (a UART Rx terminal) of the microprocessor 24.

Further, the output terminal (a collector) of the communication transistor Tr3 is connected to the communication line 21s, and the input terminal (a base) of the transistor Tr3 is connected to the communication output terminal (a UART Tx terminal) of the microprocessor 24. The output terminal (a collector) of an interlock transistor Tr2 is connected to the input terminal (the base) of the transistor Tr3, and the input terminal (a base) of the transistor Tr2 is connected to the communication line 21s via a Zener diode TH1.

The communication line 21s is provided with a short-circuit prevention resistance Rs that can prevent a short circuit in a battery pack 30 until the transistor Tr3 becomes OFF.

The charging and communication switching circuit 37 of the battery pack 30 switches the power supply line 31p of the battery pack 30 to a line for charging or a line for communication. The charging and communication switching circuit 37 of the battery pack 30 includes FET1 and FET2 that open and close a route of the power supply line 31p, and transistors Tr11 and Tr12 that operate FET1 and FET2, respectively. When the transistor Tr11 is set to be ON or OFF based on a signal (a charge ON/OFF signal) from the control microprocessor 36, FET1 is also set to be ON or OFF in the same manner. When the transistor Tr12 is set to be ON or OFF based on a signal (a comm ON/OFF signal) from the control microprocessor 36, FET2 is set to also be ON or OFF in the same manner. The diode D1 is connected in parallel to FET1 such that a charging current is shut off. The diode D2 is connected in parallel to FET2 such that a charging current is allowed to flow. Accordingly, when FET1 and FET2 are OFF, the positive terminal Pb of the battery pack 30 is electrically disconnected from the cell 32, and a voltage of the cell 32 is not applied to the positive terminal Pb.

As shown in FIG. 2, a communication line 31s is connected to the positive terminal Pb of the battery pack 30.

An input terminal of a communication FET4 is connected to the communication line 31s, and an output terminal of FET4 is connected to a communication input terminal (a UART Rx terminal) of the control microprocessor 36. A series circuit of the transistor Tr10 and the low impedance resistance RL is connected between the output terminal of FET4 and the Vcc power supply. The high impedance resistance RH is connected in parallel to the series circuit of the transistor Tr10 and the low impedance resistance RL. The transistor Tr10 can be set to be ON or OFF based on a signal (a communication start signal) from the control microprocessor 36.

The output terminal (a collector) of the communication transistor Tr3 is connected to the communication line 31s, and the input terminal (a base) of the transistor Tr3 is connected to a communication output terminal (a UART Tx terminal) of the control microprocessor 36. The output terminal (a collector) of the interlock transistor Tr2 is connected to the input terminal (the base) of the transistor Tr3, and the input terminal (a base) of the transistor Tr2 is connected to the communication line 31s via the Zener diode TH1.

The communication line 31s is provided with a short-circuit prevention resistance Rs that can prevent the short circuiting of the cell 32 until the transistor Tr3 becomes OFF.

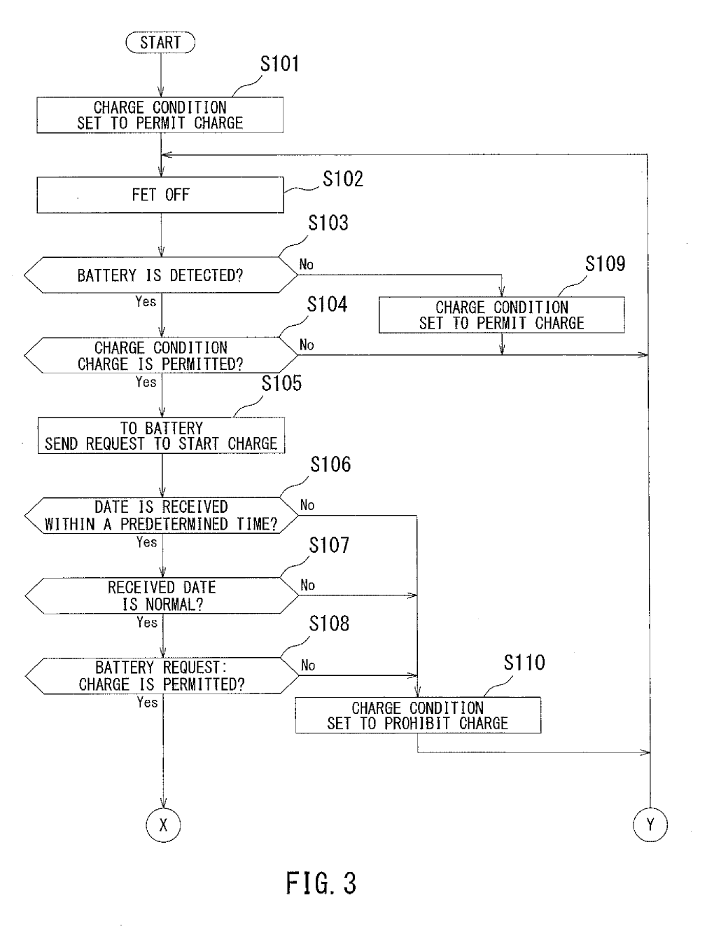

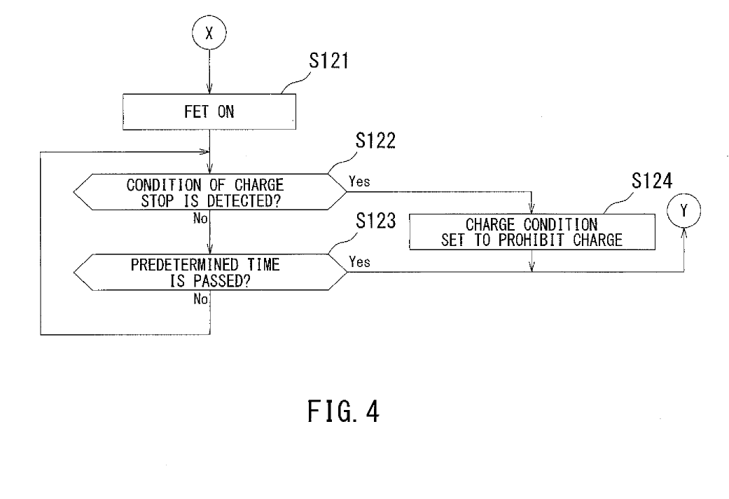

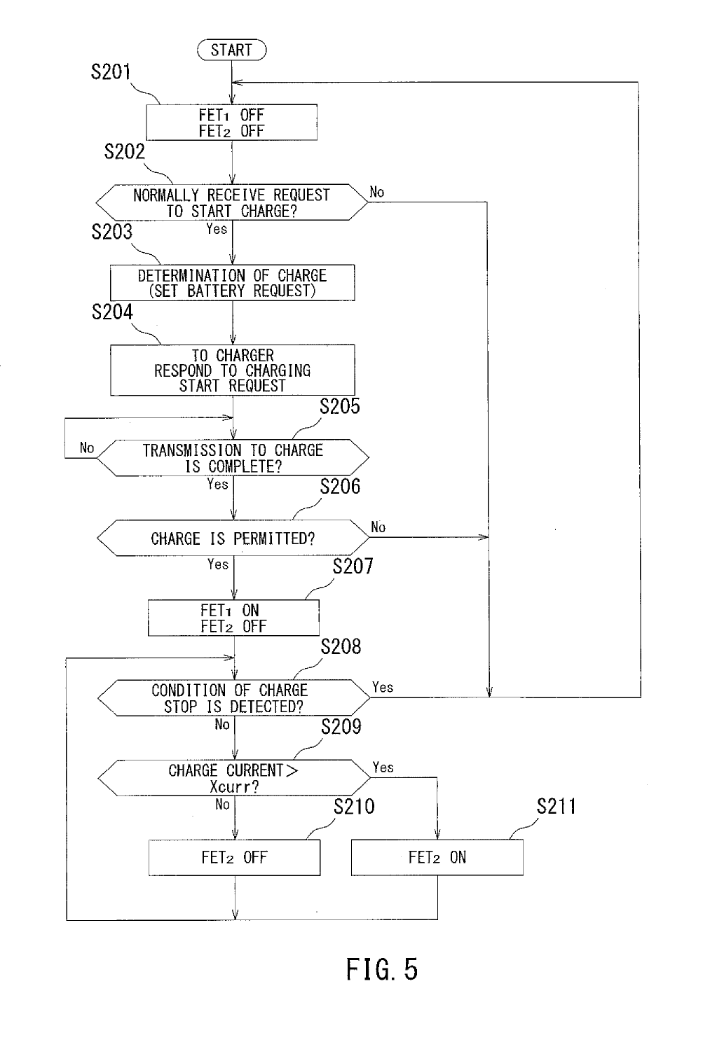

Next, operation of the charging system 10 will be described below with reference to FIGS. 3 to 5. Processes shown in FIGS. 3 and 4 are repeatedly executed at predetermined times based on a program stored in a memory of the microprocessor 24 of the charger 20. Further, processes shown in FIG. 5 are repeatedly executed at predetermined times based on a program stored in a memory of the control microprocessor 36 of the battery pack 30.

First, when the charger 20 is not connected to the battery pack 30, as shown in step S101 of FIG. 3, the charger 20 is initialized, and is set to a charging allowable state. Further, when the transistor Tr1 is set to be OFF, FET1 and FET2 are also set to be OFF, and the route of the power supply line 21p is opened (step S102 in FIG. 3). When the transistors Tr11 and Tr12 in the battery pack 30 are set to be OFF, FET1 and FET2 are set to be OFF, and the route of the power supply line 31p is opened (step S201 in FIG. 5).

When the battery pack 30 is not connected to the charger 20, the positive terminal Ps and the negative terminal Ns of the charger 20 are open, and the Vcc power supply voltage is applied to the communication line 21s (refer to FIG. 2) via the high impedance resistance RH. In this state, the transistor Tr10 is kept at OFF.

Accordingly, an inverting input voltage of the comparator COMP of the charger 20 becomes greater than a predetermined voltage (a non-inverting input voltage), and the comparator COMP outputs a low (Lo) signal to the microprocessor 24. As a result, the microprocessor 24 determines that the battery pack 30 is not connected to the charger 20.

That is, judgment of step S103 in FIG. 3 becomes NO, and the charger 20 is set to a state where charging is allowed (step S109).

Next, as shown in FIG. 2, when the battery pack 30 is connected to the charger 20, current flows from the Vcc power supply of the charger 20 via the high impedance resistance RH, the power supply line 21p, the positive terminal Ps, the positive terminal Pb of the battery pack 30, the power supply line 31p, the communication line 31s and a bias resistance RM of the communication FET4. Accordingly, a voltage drop occurs at the high impedance resistance RH of the charger 20, and voltage in the communication line 21s of the charger 20 becomes less than the predetermined voltage (the non-inverting input voltage) of the comparator COMP. As a result, the comparator COMP outputs a high (Hi) signal to the microprocessor 24 and thus, the microprocessor 24 determines that the battery pack 30 is connected to the charger 20 (YES in step S103 of FIG. 3).

Next, when the microprocessor 24 outputs an ON signal to the transistor Tr10, the transistor Tr10 is set to be ON, and the low impedance resistance RL is connected to the Vcc power supply voltage. As a result, an input voltage of the comparator COMP becomes greater than the predetermined voltage (the non-inverting input voltage), and it ensures that the comparator COMP outputs a low (Lo) signal to the microprocessor 24.

Further, in the battery pack 30, the control microprocessor 36 outputs an ON signal to the transistor Tr10, and the low impedance resistance RL is connected to the Vcc power supply.

Next, in step S104 of FIG. 3, the microprocessor 24 of the charger 20 determines whether the charger 20 is allowed to perform charging. In practicality, since the charger 20 is in a charging allowable state (YES in step S104), the microprocessor 24 transmits to the battery pack 30 a charging start request signal as to whether it is acceptable for charging to be started (step S105 in FIG. 3).

That is, the charging start request signal is transmitted from the communication output terminal (the UART Tx terminal) of the microprocessor 24 to the communication input terminal (the UART Rx terminal) of the control microprocessor 36 via the communication transistor Tr3, the communication line 21s of the charger 20, the power supply line 21p, the power supply line 31p of the battery pack 30, the communication line 31s and the communication FET4.

When the battery pack 30 (the control microprocessor 36) receives the charging start request signal (YES in step S202 of FIG. 5), the control microprocessor 36 determines whether charging can be performed based on measurement information and detection history information of the cell 32 (step S203 in FIG. 5). Next, the control microprocessor 36 responds to the charging start request signal from the microprocessor 24 of the charger 20 (step S204 in FIG. 5).

A response signal is transmitted from the communication output terminal (the UART Tx terminal) of the control microprocessor 36 to the microprocessor 24 via the communication transistor Tr3, the communication line 31s, the power supply line 31p, the power supply line 21p of the charger 20, the communication line 21s and the communication comparator COMP.

When the battery pack 30 allows a response to the charging start request from the microprocessor 24 of the charger 20 (YES in step S205 and step S206 of FIG. 5) in the battery pack 30, FET1 is set to be ON via the transistor Tr11, and the route of the power supply line 31p is closed (step S207 in FIG. 5). At this time, FET2 is OFF, but since the diode D2 connected in parallel to FET2 such that a charging current is allowed to flow, charging can occur.

In contrast, in the charger 20, when the microprocessor 24 of the charger 20 receives the response signal in a predetermined time period (YES in step S106 of FIG. 3), the received data is normal (YES in step S107) and a charging allowable signal (YES in step S108) is transmitted. As shown in step S121 of FIG. 4, FET1 and FET2 are set to be ON via the transistor Tr1 and the route of the power supply line 21p is closed. Accordingly, charging of the cell 32 of the battery pack 30 is performed.

When the charging is performed, the microprocessor 24 of the charger 20 and the control microprocessor 36 of the battery pack 30 set the communication transistor Tr3 to be OFF and thus, communication is prevented from being output to communication lines 21s and 31s. Furthermore, since transistor Tr3 is set to be OFF, charging current is prevented from flowing to the communication lines 21s and 31s.

Further, even in the situation where the microprocessor 24 outputs an ON signal to the communication transistor Tr3 due to a failure, a charging voltage (Vp) is applied to the input terminal (the base) of the interlock transistor Tr2 via the Zener diode TH1 and the transistor Tr2 is set to be ON. As a result, the voltage at the input terminal (the base) of the communication transistor Tr3 becomes zero, the communication transistor Tr3 is set to be OFF and thus, communication is prevented from being output to the communication lines 21s and 31s. Furthermore, since the transistor Tr3 is set to be OFF, charging current is prevented from flowing to the communication lines 21s and 31s.

When charging is continuously performed in this way, and it is detected in the battery pack 30 that a charging current exceeds a predetermined value Xcurr (YES in step S209 of FIG. 5), the transistor Tr12 is set to be ON and thus, FET2 is set to be ON (step S211). Accordingly, the charging current flowing through the diode D2 decreases, and heat generation of the diode D2 is suppressed.

When the charging current is equal to or less than the predetermined value Xcurr, the transistor Tr12 is set to be OFF. Accordingly, FET2 is set to be OFF (step S210), and the charging current flows through the diode D2.

When a charging stop condition is detected during charging, i.e. when the charging current becomes equal to or less than a predetermined value during charging, and a charging completion state is detected (YES in step S208 of FIG. 5), the transistors Tr11 and Tr12 are set to be OFF in step S201. Accordingly, FET1 and FET2 are set to be OFF, and the route of the power supply line 31p is opened.

When a charging stop condition is detected in the charger 20 (YES in step S122 of FIG. 4), the charger 20 is set to a charging prohibition state (step S124). In addition, in step S102 of FIG. 3, since the transistor Tr1 is set to be OFF, FET1 and FET2 are set to be OFF, and the route of the power supply line 21p is opened. When a predetermined time period of charging has passed (YES in step S123 of FIG. 4), the transistor Tr1 is set to be OFF in step S102 of FIG. 3. Accordingly, FET1 and FET2 are set to be OFF, and the route of the power supply line 21p is opened.

As a result, charging is completed. That is, in certain embodiments of the present invention, FET1 and FET2 of the charger 20 correspond to the switches located at the charger side, and FET1 and FET2 and the battery pack 30 correspond to the switches located at the battery pack side.

In the charging system 10 according to this embodiment, when the charger 20 and the battery pack 30 are connected to each other, and FET1 and FET2 (the switches) at the charger side and FET1 and FET2 (the switches) at the battery pack side are open, it is possible to use the power supply lines 21p and 31p between FET1 and FET2 at the charger side and FET1 and FET2 at the battery pack side as communication lines. For this reason, it is not necessary to separately provide the power line and the communication line between the charger 20 and the battery pack 30. That is, the connection terminals of the power supply lines 21p and 31p between the charger 20 and the battery pack 30 can be used for communication. Accordingly, it is not necessary to have the dedicated communication terminal. As a result, it is possible to reduce the number of terminals and reduce the likelihood of a terminal contact failure between the charger 20 and the battery pack 30.

When FET1 and FET2 at the charger side and FET1 and FET2 at the battery pack side are open, the power supply lines 21p and 31p between FET1 and FET2 at the charger side and FET1 and FET2 at the battery pack side are used as communication lines. For this reason, the power supply line 31p used as a communication line is electrically disconnected from the cell 32 of the battery pack 30, and communication is not affected by a cell specification of the battery pack 30.

When charging is completed, that is, when it is detected that a charging current becomes equal to or less than a predetermined value, FET1 and FET2 at the charger side and FET1 and FET2 at the battery pack side are set to be open. Accordingly, it is ensured that charging current is completely shut off when charging is completed.

When FET1 and FET2 at the charger side and FET1 and FET2 at the battery pack side are closed and charging is performed, charging voltage exceeds a Zener voltage. Accordingly, the communication transistor Tr3 is forced to be OFF due to operations of the Zener diode TH1 and the interlock transistor Tr2, and communication via the communication lines 21s and 31s is prevented. As a result, while the battery pack 30 is being charged, communication does not mistakenly occur due to erroneous operation of the microprocessor 24. Since the transistor Tr3 is forced to be OFF, charging current is prevented from flowing to the communication lines 21s and 31s.

The diode D2 is connected in parallel to FET2 at the battery pack side such that a charging current flows, and when the charging current exceeds a predetermined current, FET1 becomes ON. For this reason, a current flowing through the diode D2 decreases, and heat generation of the diode D2 can be suppressed.

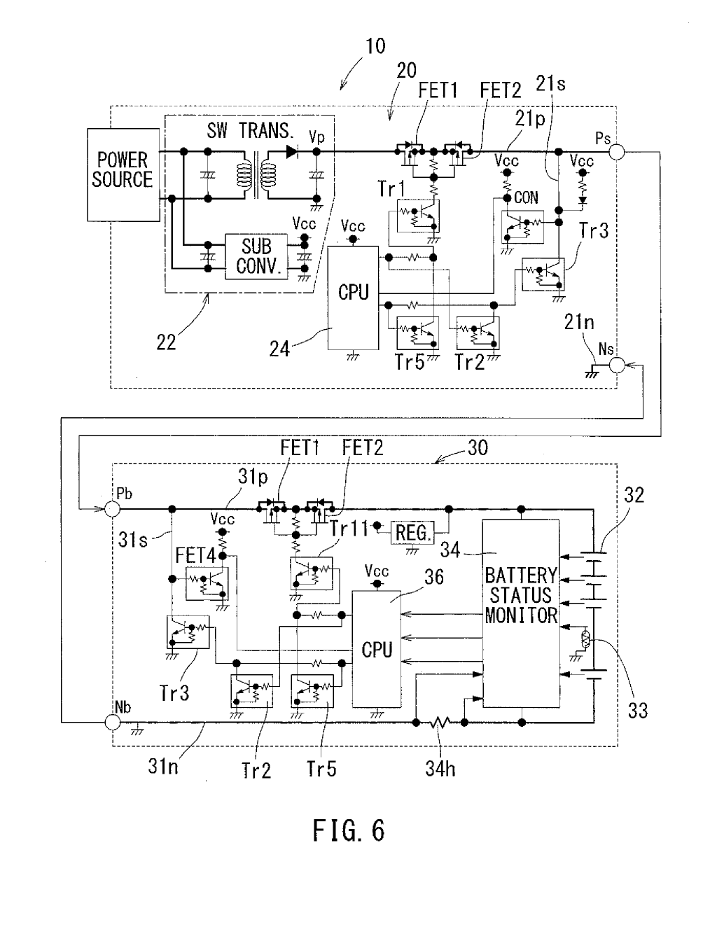

The present invention is not limited to the above-described embodiments, and can be modified without departing from the scope of the present invention. For example, as shown in FIG. 2, an above embodiment shows the interlock circuit in which the Zener diode TH1 and the interlock transistor Tr2 are used. However, as shown in FIG. 6, embodiments of the present invention can be configured to adopt an interlock circuit in which two interlock transistors Tr2 and Tr5 are used.

That is, as shown in an upper diagram (for the charger 20) of FIG. 6, the base terminal of the interlock transistor Tr2 is connected to the microprocessor 24 in common with the base terminal of the transistor Tr1 that operates FET1 and FET2. The collector terminal of the interlock transistor Tr2 is connected to the base terminal of the communication transistor Tr3. For this reason, when the transistor Tr1 is set to be ON based on a signal from the microprocessor 24, and FET1 and FET2 are set to be ON, the interlock transistor Tr2 is also set to be ON, and a voltage at the base terminal of the communication transistor Tr3 becomes zero. As a result, the communication transistor Tr3 is set to be OFF, and communication is prevented from being output to the communication line 21s.

For this reason, while charging of the cell 32 is performed, communication is not output to the communication line 21s due to an erroneous operation of the microprocessor 24. Further, charging current is prevented from flowing to the communication line 21s during charging.

A base terminal of the interlock transistor Tr5 is connected to the microprocessor 24 in common with the base terminal of the communication transistor Tr3. Further, a collector terminal of the interlock transistor Tr5 is connected to the base terminal of the transistor Tr1 that operates FET1.

For this reason, when the communication transistor Tr3 is set to be ON based on a signal from the microprocessor 24, the interlock transistor Tr5 is also set to be ON, and the voltage at the base terminal of the transistor Tr1 for the operation of FET1 becomes zero. As a result, the transistor Tr1 is set to be OFF, FET1 is OFF, and the route of the power supply line 21p is opened. That is, when communication is performed between the charger 20 and the battery pack 30, charging is prevented.

For this reason, while communication is performed between the charger 20 and the battery pack 30, charging is not started due to an erroneous operation of the microprocessor 24.

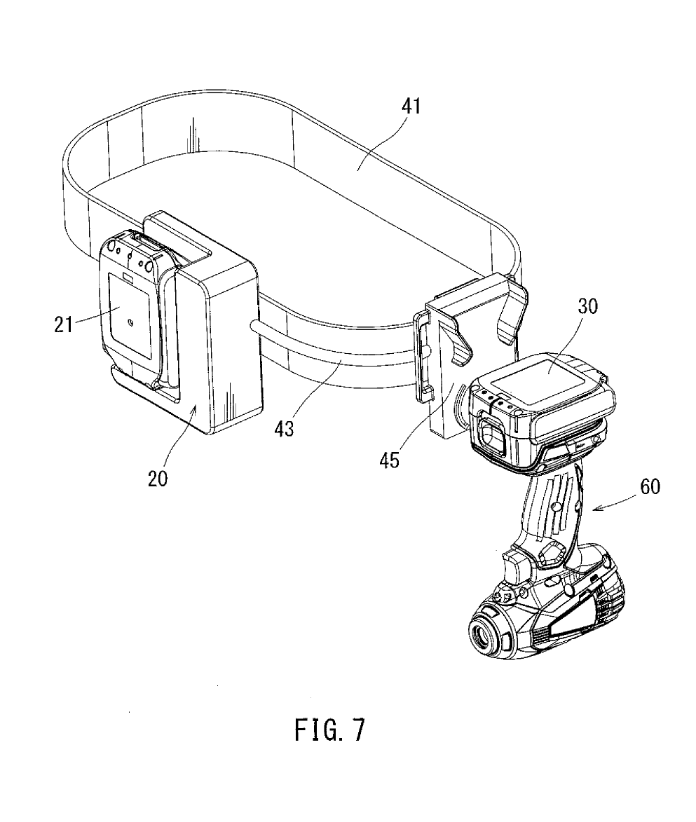

Charging systems 40 according to other embodiments of the present invention will be described below with reference to FIGS. 7 to 14.

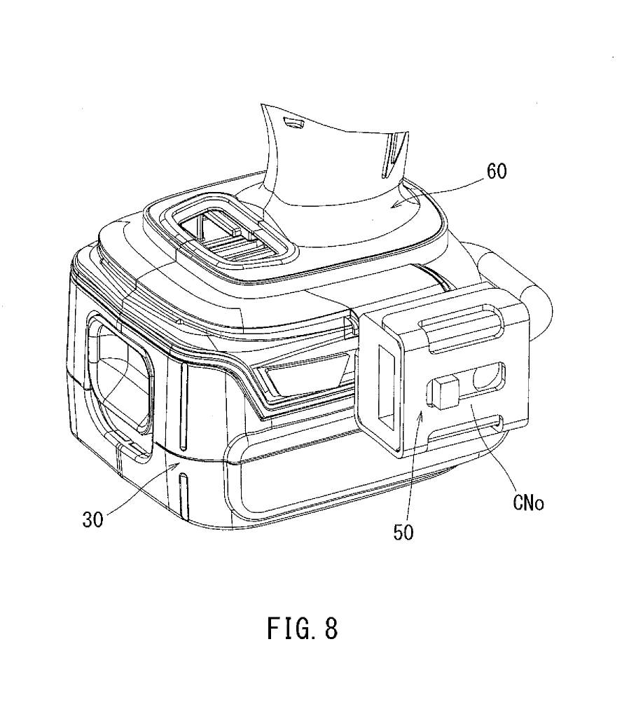

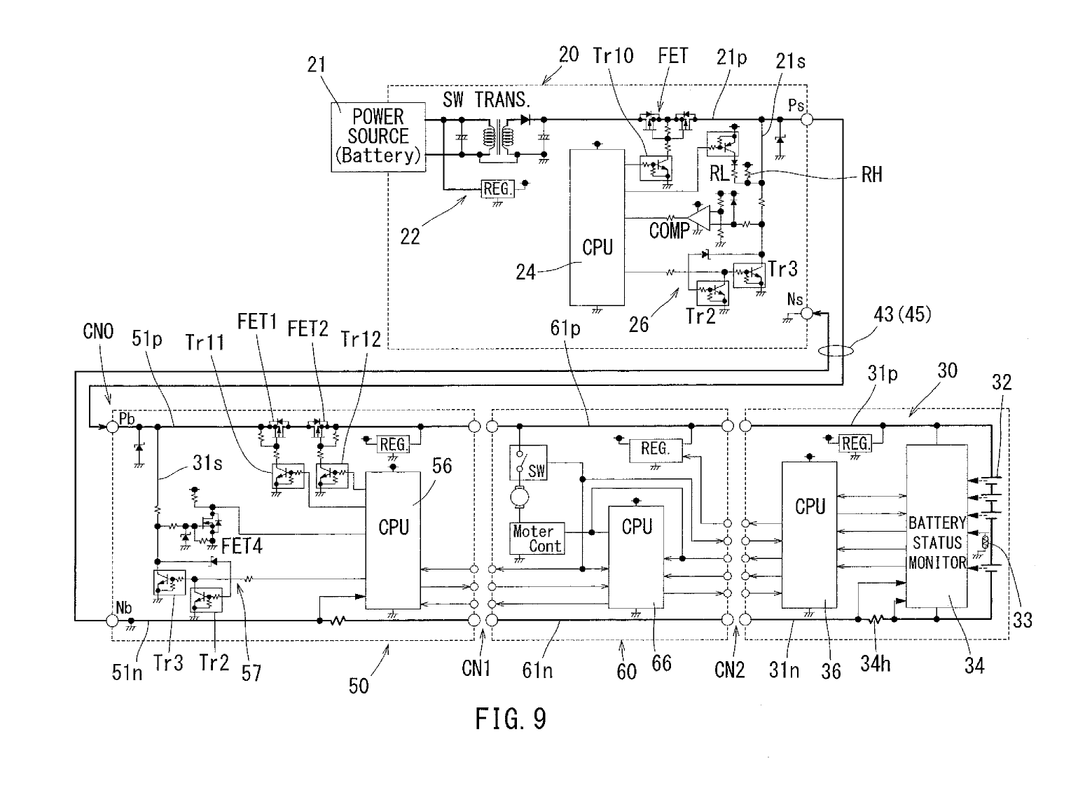

The charging system 40 according to an embodiment includes the charger 20 that is attached to a belt 41 mountable on a human body, a dedicated cable 43, and a tool holder 45 (as shown in FIG. 7). Further, the charging system 40 also includes an adapter 50 (refer to FIG. 8) that can be connected to the tool holder 45 of the charger 20, an electric power tool 60 that is connected to the adapter 50, and a battery pack 30 that is connected to the electric power tool 60. The adapter 50, the electric power tool 60 and the battery pack 30 are detachable in an integral manner from the tool holder 45 of the charger 20, and the electric power tool 60 can be used when a user tightens a screw and the like. As shown in FIG. 9, the adapter 50 and the electric power tool 60 are electrically connected to each other via a connector CN1, and the electric power tool 60 and the battery pack 30 are electrically connected to each other via a connector CN2.

Accordingly, a power supply line 51p (on a positive side) of the adapter 50, a power supply line 61p (on the positive side) of the electric power tool 60 and a power supply line 31p (on the positive side) of the battery pack 30 are connected to each other. A power supply line 51n (on a negative side) of the adapter 50, a power supply line 61n (on the negative side) of the electric power tool 60 and a power supply line 31n (on the negative side) of the battery pack 30 are also connected to each other. Further, a microprocessor 56 of the adapter 50, a microprocessor 66 of the electric power tool 60 and a microprocessor 36 of the battery pack 30 are connected to each other.

As shown in FIG. 9, the adapter 50 includes a charging and communication switching circuit 57 that has the same basic configuration as that of the charging and communication switching circuit 37 of the battery pack 30 as described above.

As shown in FIG. 9, the charger 20 has the same basic configuration as that of the charger 20 in FIG. 2, but is different from the charger 20 in FIG. 2 in that a battery 21 is used instead of a household AC power supply (refer to FIG. 7). The adapter 50 is electrically connected to the charger 20 via a connector CN0 in a state where the electric power tool 60 is supported by the tool holder 45.

The adapter 50 and the electric power tool 60 correspond to the instruments disposed between the charger and the battery pack.

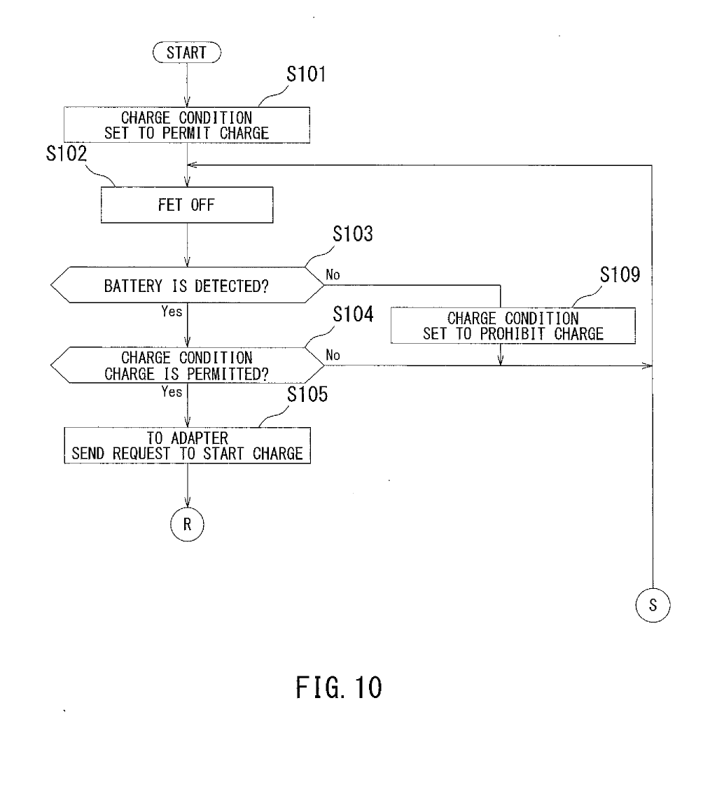

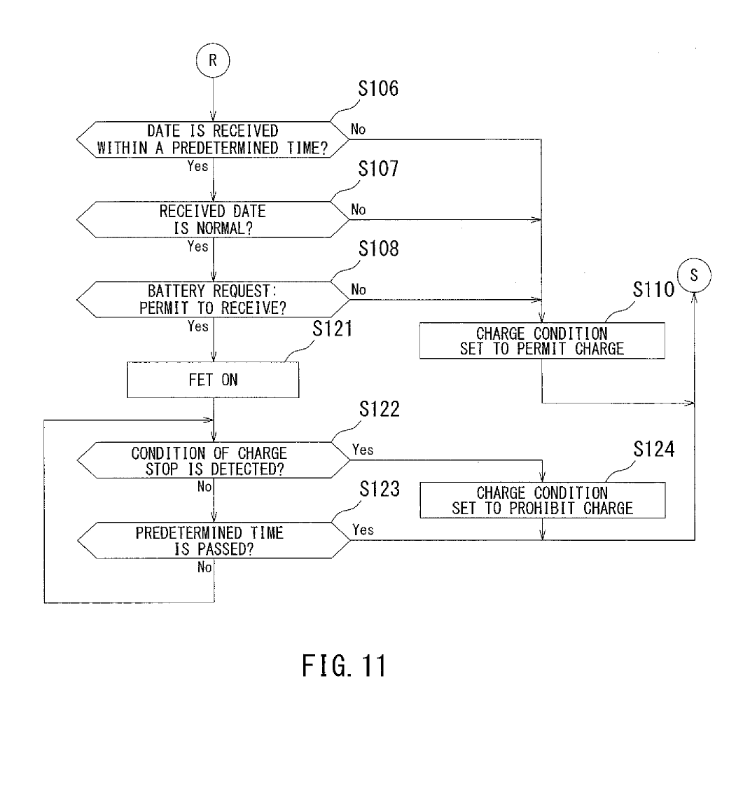

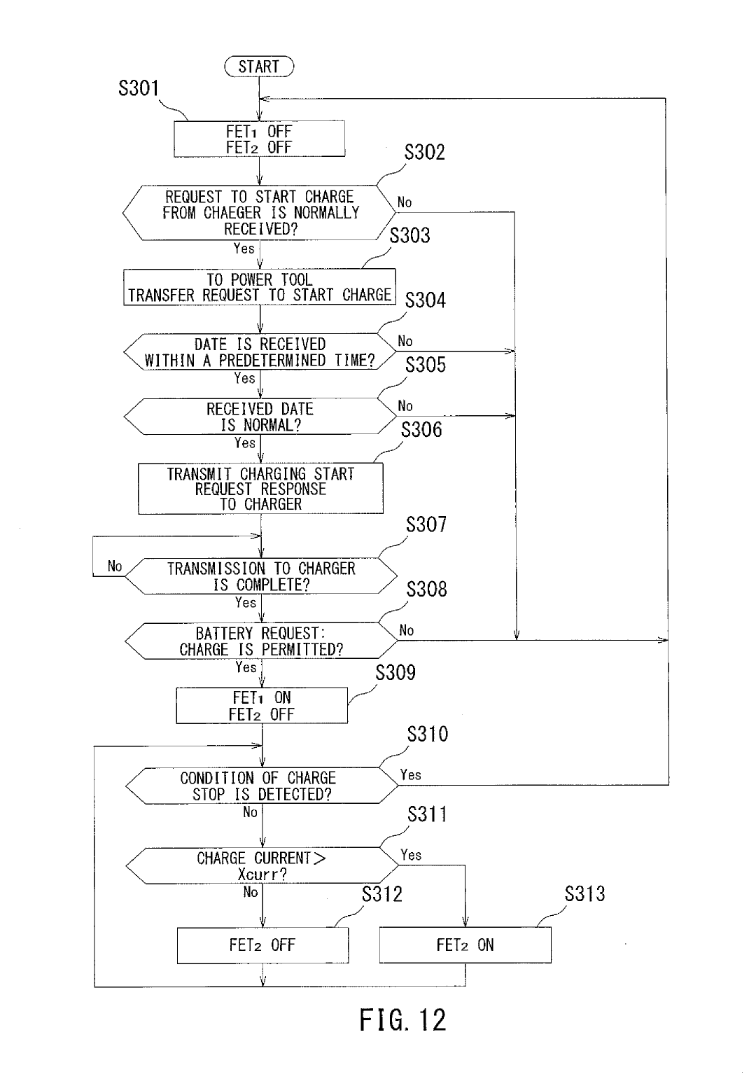

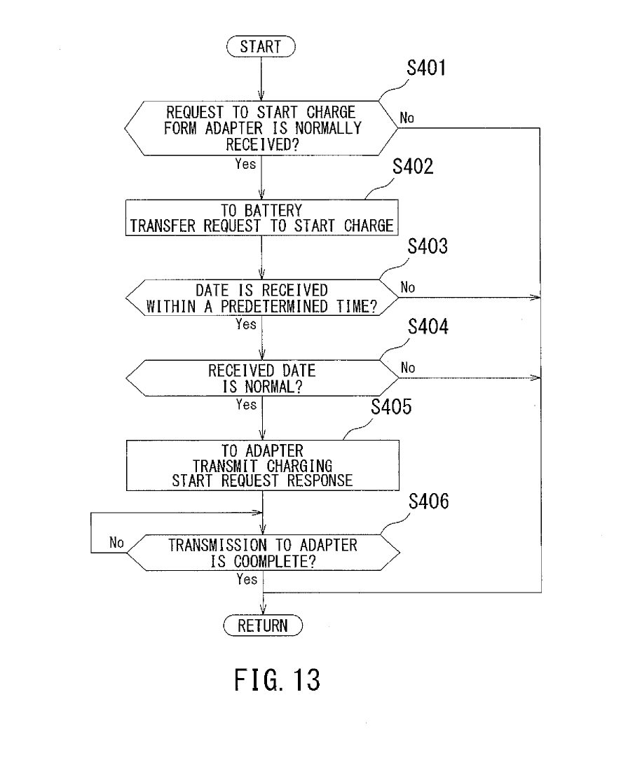

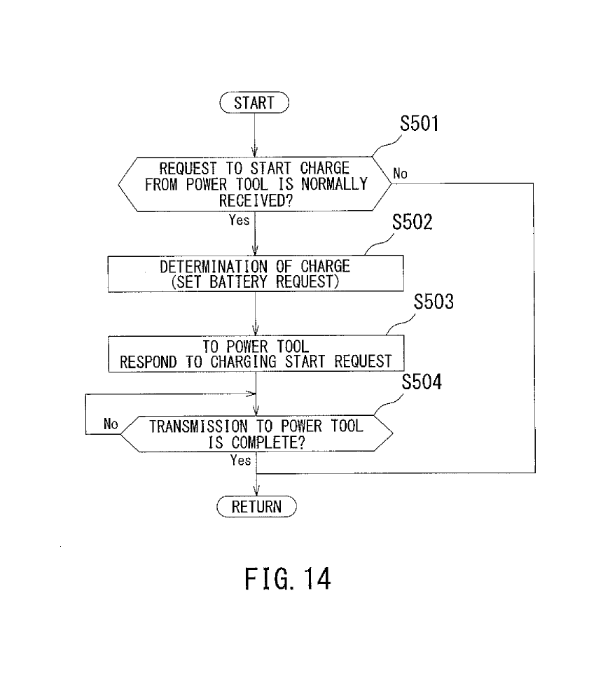

Next, an operation of the charging system 40 will be described below with reference to flow charts in FIGS. 10 to 14. Processes shown in FIGS. 10 and 11 are repeatedly executed at predetermined times based on a program stored in a memory of the microprocessor 24 of the charger 20. Processes shown in FIG. 12 are repeatedly executed at predetermined times based on a program stored in a memory of the microprocessor 56 of the adapter 50. Processes shown in FIG. 13 are repeatedly executed based on a program stored in a memory of the microprocessor 66 of the electric power tool 60. Further, processes shown in FIG. 14 are repeatedly executed based on a program stored in a memory of the microprocessor 36 of the battery pack 30.

Since the processes executed in the charger 20 shown in FIGS. 10 and 11 are basically the same as those which are shown in FIGS. 3 and 4 and described above, the same step numbers are assigned to the same processes, and detailed descriptions thereof will be omitted.

First, before the adapter 50 is connected to the charger 20, the charger 20 is initialized, FET1 and FET2 are set to be OFF, and the route of the power supply line 21p is opened (steps S101 and S102 in FIG. 10). In the adapter 50, FET1 and FET2 are set to be OFF, and a route of the power supply line 51p is opened (step S301 in FIG. 12).

Next, when the adapter 50 is connected to the charger 20 (YES in step S103 of FIG. 10), and the charger 20 is in a charging allowable state (YES in step S104), the microprocessor 24 of the charger 20 transmits to the microprocessor 56 of the adapter 50 a charging start request signal as to whether it is acceptable for charging to be started (step S105).

When the microprocessor 56 of the adapter 50 receives the charging start request signal from the charger 20 (YES in step S302 of FIG. 12), the microprocessor 56 transmits a charging start request signal to the microprocessor 66 of the electric power tool 60 (step S303 in FIG. 12). When the microprocessor 66 of the electric power tool 60 receives the charging start request signal from the adapter 50 (YES in step S401 of FIG. 13), the microprocessor 66 transmits a charging start request signal to the microprocessor 36 of the battery pack 30 (step S402 in FIG. 13). When the microprocessor 36 of the battery pack 30 receives the charging start request signal from the electric power tool 60 (YES in step S501 of FIG. 14), the control microprocessor 36 determines whether charging can be performed based on measurement information and detection history information of the cell 32 (step S502 in FIG. 14). Next, the control microprocessor 36 responds to the charging start request from the microprocessor 66 of the electric power tool 60 (YES in steps S503 and S504 of FIG. 14). When the microprocessor 66 of the electric power tool 60 receives the response signal from the battery pack 30 within a predetermined time period (step S403 in FIG. 13), and response data is normal (step S404 in FIG. 13), the microprocessor 66 transmits a charging start request response to the microprocessor 56 of the adapter 50 (YES in steps S405 and S406 of FIG. 13). When the microprocessor 56 of the adapter 50 receives the response from the electric power tool 60 within a predetermined time period (YES in step S304 of FIG. 12), and response data is normal (YES in step S305 of FIG. 12), the microprocessor 56 transmits a charging start request response to the microprocessor 24 of the charger 20 (YES in steps S306 and S307 of FIG. 12).

When the microprocessor 56 of the adapter 50 allows a response to the charging start request from the microprocessor 24 of the charger 20 (YES in step S308 of FIG. 12), the microprocessor 56 sets FET1 to be ON and closes the route of the power supply line 51p (step S309 in FIG. 12). At this time, FET2 is OFF, but since the diode D2 is connected in parallel to FET2 such that a charging current is allowed to flow, charging can be performed.

In contrast, when the microprocessor 24 of the charger 20 receives the response signal in a predetermined time period (YES in step S106 of FIG. 11), the received data is normal (YES in step S107), and the received data is a charging allowable signal (YES in step S108), FET1 and FET2 are set to be ON, and the route of the power supply line 21p is closed (step S121 in FIG. 11). Accordingly, charging of the cell 32 of the battery pack 30 is performed.

When charging is continuously performed in this way, and it is detected that a charging current exceeds a predetermined value Xcurr in the adapter 50 (YES in step S311 of FIG. 12), FET2 is set to be ON (step S313). Accordingly, charging current flowing through the diode D2 decreases, and heat generation of the diode D2 is suppressed.

When a charging current is equal to or less than the predetermined value Xcurr, FET2 is set to be OFF (step S312), and charging current flows through the diode D2.

When a charging stop condition is detected during charging, i.e. when charging current becomes equal to or less than a predetermined value during charging, and the charging completion state is detected (YES in step S310 of FIG. 12), FET1 and FET2 are set to be OFF in step S301, and the route of the power supply line 31p is opened.

When a charging stop condition is detected in the charger 20 (YES in step S122 of FIG. 11), the charger 20 is set to a charging prevention state (step S124). In addition, in step S102 of FIG. 10, FET1 and FET2 are set to be OFF, and the route of the power supply line 21p is opened. Then, charging is completed.

In this way, the battery pack 30 integrally connected with the electric power tool 60 can be charged using the charger 20 and the adapter 50. Data can be transmitted between the charger 20 and the battery pack 30 via the power supply lines 21p and 51p.

The present invention is not limited to the above-described embodiments, and can be modified without departing from the scope of the present invention. Some of the above embodiments show a structure in which the charger 20 is attached to the belt. However, it is possible to adopt a desktop type charger as the charger 20 and to drive the charger 20 using a commercial power supply.

Further, some of the above embodiments show an electric drill, an electric driver or the like as the electric power tool 60. However, it is possible to use an electric wrench, an electric grinder, an electric circular saw, an electric reciprocating saw, an electric jigsaw, an electric hammer, an electric cutter, an electric chain saw, an electric planer, an electric nail gun (including a tacker), an electric hedge trimmer, an electric lawn mower, an electric lawn clipper, an electric bush cutter, an electric cleaner, or the like as the electric power tool 60.

We claim:

1. A charging system comprising:
a charger and a battery pack wherein the charger and the battery pack can be connected to each other directly or indirectly via a separate instrument, and a charging current can flow to a cell of the battery pack via power supply lines in a state where the charger and the battery pack are connected, wherein:
each power supply line at a charger side and a battery pack side is provided with a switch for opening and closing a route of each power supply line; and
when the charger and the battery pack are connected to each other and the switch at the charger side and the switch at the battery pack side are set to be open, power supply lines between the switch at the charger side and the switch at the battery pack side can be used as a communication line.

2. The charging system according to claim 1, wherein when it is detected that a charging current becomes equal to or less than a predetermined value, the switch at the charger side and the switch at the battery pack in the power supply lines are set to be open.

3. The charging system according to claim 1, further comprising an interlock means for prohibiting an inflow of a charging current to the communication line when the switch at the charger side in the power supply lines is set to be closed or for prohibiting an inflow of a discharging current from the battery pack when the switch at the battery pack side in the power supply lines is set to be closed.

4. The charging system according to claim 1, wherein when communication is performed using the communication line, the interlock means opens the switch at the charger side and the switch at the battery pack side in the power supply lines.

5. The charging system according to claim 1, wherein:
the switch at the battery pack side includes a first switching element and a second switching element that are connected in series to each other and a diode that is connected in parallel to the first switching element such that a charging current flows; and
when the charging current is equal to or less than a predetermined current value, the first switching element connected in parallel to the diode is set to be OFF, and when the charging current exceeds the predetermined current value, the first switching element is set to be ON.
